(19) United States
(12) Patent Application Publication
(10) Pub. No.: US 2026/0223881 A1
(43) Pub. Date: Aug. 6, 2026

(54) METHOD OF MANUFACTURING A CHOCOLATE PRODUCT

(71) Applicant: Kraft Foods Schweiz Holding GmbH, Zug (CH)

(72) Inventors: Catherine Clark, Birmingham (GB); David Brown, Birmingham (GB); Gareth Timmins, Birmingham (GB)

(21) Appl. No.: 19/151,266

(22) PCT Filed: Jan. 30, 2024
(86) PCT No.: PCT/EP2024/052135

§ 371 Date: Jul. 25, 2025

(30) Foreign Application Priority Data
Feb. 9, 2023 (GB) 2301848.4

(51) Int. Cl. A23G 1/00

(52) U.S. Cl. CPC A23G 1/0033; A23G 1/0036

(57) ABSTRACT

The invention provides a method of manufacturing a chocolate product comprising the steps of: a) size reducing a chocolate ingredient mixture followed by conching the chocolate ingredient mixture; and b) ball milling the chocolate ingredient mixture formed in step a) to form a chocolate product comprising a particle size distribution which is reduced compared to the chocolate ingredient mixture formed in step a), wherein the chocolate ingredient mixture at the end of step a) comprises a particle size distribution with a D90 value of 20-100 μm and the chocolate product at the end of step b) comprises a particle size distribution with a D90 value of 15-35 μm and which is less than the particle size distribution formed in step a).

### TECHNICAL FIELD OF THE INVENTION

The present invention relates to a method of manufacturing a chocolate product.

### BACKGROUND TO THE INVENTION

A typical chocolate manufacturing process comprises the following steps: 1) grinding the cocoa nibs and mixing the resulting cocoa product with the remaining chocolate ingredients, 2) size reducing the chocolate ingredient mixture by refining to reduce the particle size to the desired particle size of the end chocolate product, 3) conching the chocolate product and 4) tempering and solidifying the chocolate product to form a solid chocolate product.

The conching step breaks up aggregates, and evenly distributes cocoa butter within the chocolate ingredient mixture. The conching step does not typically reduce the particle size significantly and therefore the refining step is required to reduce the particle size to the desired size to produce a smooth, grit free chocolate product. The size reduction (e.g., refining) step typically takes a long time and can have a low throughput. By reducing the particle size to the desired low particle size of the end product (typically 12-28 μm) in the initial refining step, the refining equipment is often worn out and therefore may need replacing at regular intervals to ensure that the end product remains consistent.

It would therefore be advantageous to provide a method of manufacturing a chocolate product wherein the degree of the initial size reduction step is reduced, and the throughput of the chocolate product is increased to increase manufacturing efficiency.

It would be advantageous to provide a method of manufacturing a chocolate product wherein the particle size at the end of the initial size reduction step is higher than desired in the end product such that the size reduction apparatus is less likely to become damaged or worn during manufacture, or less frequently so. It would be advantageous to provide a method of manufacturing a chocolate product which increases equipment lifetime and reduces maintenance downtime.

It would also be advantageous to provide a method of manufacturing a chocolate product wherein the resulting chocolate product is of a consistent quality, in particular wherein the end product particle size is of the desired distribution to create a desired mouthfeel without a gritty or gummy texture.

It is an aim of embodiments of the invention to overcome one or more problems of the prior art, whether expressly disclosed herein or not.

### SUMMARY OF THE INVENTION

According to a first aspect of the invention there is provided a method of manufacturing a chocolate product comprising the steps of:
a) size reducing a chocolate ingredient mixture followed by conching the chocolate ingredient mixture; and
b) ball milling the chocolate ingredient mixture formed in step a) to a chocolate product comprising a reduced particle size distribution, wherein the chocolate ingredient mixture at the end of step a) comprises a particle size distribution with a D90 value of 20-100 μm and the chocolate product at the end of step b) comprises a particle size distribution with a D90 value of 15-35 μm and which is less than the particle size distribution formed in step a).

Particle size distribution and D90 values may be measured using a Malvern Mastersizer 3000 (supplied by Malvern Panalytical Ltd, UK), for example.

The ball milling step of step b), after step a), may be advantageous because it reduces the amount of size reduction required in step a) of the manufacturing process because the particle size distribution of the chocolate ingredient mixture at the end of step a) remains higher than the desired particle size distribution of the end chocolate product. The throughput of the ball milling step is significantly higher than the size reduction step and therefore by reducing the duration of the size reduction step, and adding the ball milling step, the method of the invention increases the overall throughput of the chocolate product when compared to a method of manufacturing which does not comprise a ball milling step after the initial size reduction and conching step, thereby increasing manufacturing efficiency and reducing costs.

In some embodiments the size reduction step comprises a refining step. In some embodiments the size reduction step is performed with at least one roll refiner. The roll refiner may be a 2-roll roll refiner, a 3-roll roll refiner or a 5-roll roll refiner. The size reduction step may be performed with at least 2, 3, 4 or 5 roll refiners. The at least 2 roll refiners may be arranged in series or in parallel.

In embodiments wherein the size reduction step comprises at least 2 roll refiners the roll refiners may be the same or they may be different. Step a) may comprise size reducing the chocolate ingredient mixture by refining in a 2-roll roll refiner followed by a 5-roll roll refiner. Step a) may comprise size reducing the chocolate ingredient mixture by refining in a 3-roll roll refiner followed by a 5-roll roll refiner. Step a) may comprise size reducing the chocolate ingredient mixture by refining in a 2-roll roll refiner followed by a 3-roll roll refiner. Step a) may comprise size reducing the chocolate ingredient mixture by refining in a 2-roll roll refiner followed by a 3-roll roll refiner followed by a 5-roll roll refiner.

In some embodiments the size reduction step comprises a milling step. In some embodiments the milling size reduction step is performed with at least one hammer mill. In some embodiments the size reduction step comprises a grinding step.

Prior to the size reduction step of step a), the chocolate ingredient mixture may comprise a particle size distribution with a D90 value of at least 50 μm, 100 μm, 200 μm, 300 μm, 400, μm, 500 μm, 700 μm, 900 μm or at least 1000 μm. Prior to the size reduction step of step a), the chocolate ingredient mixture may comprise a particle size distribution with a D90 value of no more than 3000 μm, 2500 μm, 2000 μm, 1800 μm, 1600 μm or preferably no more than 1500 μm. The chocolate ingredient mixture prior to the size reduction step may comprise a particle size distribution with a D90 value of between 50 μm and 3000 μm, or between 100 μm and 2000 μm, or between 100 μm and 1750 μm, or between 100 and 1500 μm or a D90 value of between 200 μm and 1500 μm.

The particle size distribution of the chocolate ingredient mixture after the size reduction step of step a) may comprise a D90 value of no more than 100 μm, 80 μm, 60 μm, 50 μm or no more than 40 μm. The particle size distribution of the chocolate ingredient mixture after the size reduction step of step a) may comprise a D90 value of at least 20 μm, 25 μm, 30 μm, 35 μm or at least 40 μm. The particle size distribution of the chocolate ingredient mixture after the size reduction step of step a) may comprise a D90 value of between 100 μm and 20 μm, or between 80 μm and 20 μm, or between 60 μm and 20 μm, or between 40 μm and 20 μm, or between 40 μm and 28 μm, or between 35 μm and 28 μm, or between 35 μm and 30 μm.

In some embodiments, the particle size distribution of the chocolate ingredient mixture is reduced from a D90 value of between 100 μm and 1800 μm to a D90 value of between 20 μm and 80 μm in the size reduction step of step a). In some embodiments, the particle size distribution of the chocolate ingredient mixture is reduced from a D90 value of between 100 μm and 1500 μm to a D90 value of between 20 μm and 80 μm in the size reduction step of step a). In some embodiments, the particle size distribution of the chocolate ingredient mixture is reduced from a D90 value of between 100 μm and 1700 μm to a D90 value of between 20 μm and 40 μm in the size reduction step of step a). In some embodiments, the particle size distribution of the chocolate ingredient mixture is reduced from a D90 value of between 100 μm and 1500 μm to a D90 value of between 20 μm and 40 μm in the size reduction step of step a). In preferred embodiments, the particle size distribution of the chocolate ingredient mixture is reduced from a D90 value of at least 150 μm to a D90 value of between 30 μm and 35 μm in the size reduction step of step a). Size reducing the chocolate ingredient mixture to a particle size distribution with a D90 value which is higher than the desired particle size distribution of the final product, may be advantageous because it may reduce the initial size reduction time of the manufacturing process thereby saving time and energy. Size reducing the chocolate ingredient mixture to a particle size distribution with a D90 value which is higher than the desired particle size distribution of the final product can also be advantageous because it can prevent damage or wearing of the size reduction apparatus, thereby extending equipment lifetime and reducing maintenance downtime. In embodiments wherein the size reduction step is a refining step which takes place in at least one roll refiner, size reducing the chocolate ingredient mixture to a particle size distribution with a D90 value which is higher than the desired particle size distribution of the final product can be advantageous because it can prevent damage or wearing of the rollers.

The conching step may comprise a wet conching step or a dry conching step. In some embodiments the conching step may comprise a dry conching step followed by a wet conching step.

In some embodiments the particle size may not be further reduced in the conching step after the size reduction step of step a) and before the ball milling step of step b). The particle size of the chocolate ingredient mixture after the conching step of step a) may comprise a D90 value of between 100 μm and 20 μm, or between 80 μm and 20 μm, or between 60 μm and 20 μm, or between 40 μm and 20 μm, or between 40 μm and 28 μm, or between 35 μm and 28 μm. In preferred embodiments the particle size of the chocolate ingredient mixture at the end of step a), following the size reduction step and the conching step, may comprise a D90 value of between 35 μm and 30 μm. The particle size of the chocolate ingredient mixture after the conching step of step a) may be higher than the desired particle size of the chocolate product.

During step b) the particle size distribution of the chocolate ingredient mixture may be reduced to the desired particle size distribution of the chocolate product produced at the end of step b). The chocolate product after step b) may comprise a particle size distribution with a D90 value of between 15 μm and 35 μm, or between 15 μm and 25 μm, or between 15 μm and 20 μm, or between 20 μm and 30 μm, or between 20 μm and 28 μm, or between 22 μm and 27 μm, or a D90 value of between 22 μm and 25 μm. This embodiment may be advantageous because it creates a chocolate product with the desired mouthfeel without a gritty texture which can be experienced with higher particle sizes, or a gummy texture which can be experienced with lower particle sizes.

The D90 particle size of the chocolate ingredient mixture at the end of step a) may be reduced in the ball milling step of step b) by between 2 μm and 80 μm. in some embodiments the D90 particle size of the chocolate ingredient mixture at the end of step a) may be reduced in the ball milling step of step b) by between 2 μm and 60 μm, or by between 2 μm and 40 μm, 2 μm and 30 μm, 2.5 μm and 25 μm, 2.5 μm and 20 μm, 2.5 μm and 15 μm or between 2.5 μm and 12 μm. In some embodiments the D90 particle size of the chocolate ingredient mixture at the end of step a) may be reduced in the ball milling step of step b) by between 5 μm and 15 μm or between 3 μm and 15 μm.

The ball milling step of step b) may be carried out at a temperature of between 30° C. and 80° C., or between 30° C. and 70° C., or between 35° C. and 65° C., or between 40° C. and 65° C., 45° C. and 80° C. or at a temperature of between 45° C. and 65° C. The reduced particle size chocolate product may exit the ball mill at a product temperature of no more than 70° C. In some embodiments the reduced particle size chocolate product may exit the ball mill at a product temperature of no more than 50° C. The reduced particle size chocolate product may exit the ball mill at a product temperature of no more than 68° C., 65° C., 62° C., 60° C., 58° C., 55° C., 52° C. or no more than 50° C.

The ball milling step of step b) may be carried out in a ball mill wherein the ball mill may be partially filled with beads. The ball mill may be at least 50% filled with beads or at least 55%, 60%, 65%, 70%, 80% or at least 90% filled with beads. The beads may be between 2 mm and 8 mm in diameter. The beads may be selected from the group consisting of be 3 mm beads, 4 mm beads, 5 mm beads and combinations thereof. The ball mill may comprise beads of more than one size. The ball mill may comprise 3 mm beads and 5 mm beads. The amount of 3 mm beads may be between 60% and 80% of the total amount of beads within the ball mill. The amount of 5 mm beads may be between 20% and 40% of the total amount of beads within the ball mill. In some embodiments the amount of 3 mm beads may be between 60% and 80% of the total amount of beads within the ball mill and the amount of 5 mm beads may be between 20% and 40% of the total amount of beads within the ball mill. The beads may be any suitable material for examples steel, stainless steel, ceramic or rubber.

The ball milling step may be carried out in a ball mill wherein the tip speed of the internal shaft is at least 3 m/s. The ball milling step may be carried out in a ball mill wherein the tip speed of the internal shaft is at least 4 m/s, 5 m/s or at least 6 m/s. The ball milling step may be carried out in a ball mill wherein the tip speed of the internal shaft is no more than 15 m/s, 14 m/s, 13 m/s or no more than 12 m/s. The ball milling step may be carried out in a ball mill wherein the tip speed of the internal shaft is between 3 m/s and 15 m/s, between 4 m/s and 14 m/s or between 4 m/s and 12 m/s.

The chocolate ingredient mixture comprises at least one ingredient selected from the group comprising cocoa nibs, cocoa powder, cocoa butter and cocoa liquor.

The term ‘chocolate’ in the context of the present invention is not restricted by the various definitions of chocolate provided by government and regulatory bodies. “Chocolate” is simply a product that contains a fat phase and which comprises cocoa products and optionally sweeteners. Other optional components of chocolate include milk components (e.g. milk fat and milk powder).

The chocolate ingredient mixture may comprise at least one fat. The fat may comprise cocoa butter. The cocoa butter may be natural cocoa butter isolated from cocoa mass. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate ingredient mixture comprises cocoa butter.

CBEs are defined in Directive 2000/36/EC. Suitable CBEs include illipe, Borneo tallow, tengkawang, palm oil, sal, shea, kokum gurgi and mango kernel. CBE's are usually used in combination with cocoa butter. In one embodiment, the chocolate comprises no more than 5 wt. % CBEs.

The chocolate ingredient mixture may comprise a cocoa butter substitute (CBS) (sometimes known as a cocoa butter replacer, CBR) in addition to, or in place of some or all of the cocoa butter. Such chocolate materials are sometimes known as compound chocolate. Suitable CBSs include CBS laurics and CBS non-laurics. CBS laurics are short-chain fatty acid glycerides. Their physical properties vary but they all have triglyceride configurations that make them compatible with cocoa butter. Suitable CBSs include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS non-laurics include soya, cottonseed, peanut, rapeseed and corn (maize) oil.

The chocolate may comprise at least one vegetable fat that is liquid at standard ambient temperature and pressure (SATP, 25° C. and 100 kPa). Suitable vegetable fats include corn oil, cotton seed oil, rapeseed oil, palm oil, safflower oil, and sunflower oil. The chocolate ingredient mixture may comprise up to 15, 10 or 5% wt. vegetable fat.

The chocolate ingredient mixture may comprise at least 5%, 10%, 15%, 20%, 25%, 30%, 35% or at least 40% wt. cocoa butter and/or cocoa butter substitute.

The chocolate ingredient mixture may comprise at least one emulsifier. The emulsifier may be a natural or artificial emulsifier. The chocolate ingredient mixture may comprise no more than 5% wt. emulsifier, or no more than 4%, 3%, 2%, 2.5%, 1% wt. or no more than 0.5% wt. emulsifier. Suitable emulsifiers include lecithin, ammonium phosphatides and PGPR, for example.

In some embodiments the chocolate ingredient mixture may comprise at least one milk product. Suitable milk products include cream, full fat milk, skimmed milk and/or whey. The milk product may comprise powdered milk solids such as powdered milk, powdered cream or whey powder. The chocolate ingredient mixture may comprise between 2 and 50% wt. milk products. The chocolate ingredient mixture may comprise between 10% and 40% wt. milk products, between 15 and 35% wt. or between 20% and 40% wt. milk products.

In some embodiments the chocolate ingredient mixture may comprise at least one sweetener. In some embodiments the chocolate ingredient mixture may comprise at least one natural and/or artificial sweetener. The sweetener may comprise a saccharide, which may be selected from the group comprising a monosaccharide, a disaccharide, an oligosaccharide, a polysaccharide or a combination thereof. Each saccharide sweetener may be independently selected from the group consisting of glucose, fructose, lactose, galactose, dextrose, polydextrose, invert fructose syrup, invert corn syrup and sucrose. In some embodiment the sweetener may include or be sucrose. The sweetener may comprise a polyol (polyhydric alcohol), which may be selected from the group consisting of sorbitol, mannitol, maltitol, erythritol, xylitol, isomalt and any combination thereof. The sweetener may have a higher sweetening power than sucrose. The sweetener may be selected from the group comprising water-soluble sweeteners, water-soluble artificial sweeteners, dipeptide-based sweeteners, protein-based sweeteners or bulking agents, or combinations thereof. The amount of sweetener may be no more than 55% wt. of the chocolate ingredient mixture, or no more than 50%, 45%, 40%, 35%, 30%, 25%, 20% or no more than 15% wt. of the chocolate ingredient mixture.

In some embodiments the chocolate ingredient mixture may comprise at least one flavouring. The flavouring may be a natural flavouring or an artificial flavouring. Examples of suitable flavouring include but are not limited to spearmint oil, cinnamon oil, peppermint oil, oil of bitter almonds, cassia oil, vanilla, citrus oils including lemon, orange, lime, grapefruit, and fruit essences including apple, pear, peach, grape, strawberry, raspberry, cherry etc., or aldehydes and esters such as cinnamyl acetate, cinnamaldehyde, citral diethylacetal, dihydrocarvyl acetate, eugenyl formate and p-methylamisol.

In some embodiments, the chocolate ingredient mixture in step a) comprises at least non-fat cocoa solids, cocoa butter and/or a fat, and a sweetener. In some embodiments the ingredient mixture in step a) comprises at least cocoa liquor, a sweetener and cocoa butter. In other embodiments the chocolate ingredient mixture in step a) may comprise milk chocolate, dark chocolate, white chocolate, or compound chocolate.

In some embodiments, no additional chocolate ingredients are added to the chocolate ingredient mixture during step a) or between step a) and step b). In alternative embodiments, additional ingredients may be added to the chocolate ingredient mixture during the size reduction step of step a). In some embodiments, additional ingredients may be added to the chocolate ingredient mixture during the conching step of step a).

In some embodiments, no additional chocolate ingredients are added to the chocolate ingredient mixture during step b). This embodiment may be advantageous because the size reduced chocolate ingredient mixture at the end of step a) may be transferred into the ball milling step of step b) for a final size-reduction step to produce the chocolate product of the desired particle size.

The chocolate ingredient mixture may be a liquid during step a), between step a) and step b), and during step b). The chocolate ingredient mixture may be a paste during the size reduction step of step a) and then conched to a liquid or paste during the conching step of step a). The chocolate ingredient mixture at the end of step a) may be stored as a liquid prior to step b). The size reduced chocolate product formed at the end of step b) may be a liquid or paste. In a step following step b), the chocolate product may be stored as a liquid prior to solidifying into a solid chocolate product.

In some embodiments, in a step following step b) the chocolate product may be cooled by being passed through a suitable heat exchanger such that the temperature of the chocolate product may be reduced to a temperature of between 40° C. and 60° C. or between 40° C. and 50° C. After the chocolate product temperature is reduced, the chocolate product may be stored as a liquid prior to solidifying into a solid chocolate product.

In a step following step b) the chocolate product may be tempered before it is solidified into a solid chocolate product. In the tempering step, the liquid chocolate product is subjected to tempering so as to control the crystallization of the cocoa butter in the chocolate mass. Tempering may not have to be carried out, depending on the fat component used. Tempering is generally known in the art, but it may be carried out at a temperature not exceeding 50° C., preferably at a temperature of at least 35° C. A preferred temperature range for the tempering step is 35° C. to 40° C.

The chocolate product may be solidified by moulding. The chocolate product may be solidified by filling a moulded shell followed by backing off thereby creating a solid chocolate shell or moulded shape. The chocolate product may be solidified by enrobing the chocolate product over another product such as a confectionery product. The chocolate product may be solidified by cold stamping the product into a desired shape.

In a second aspect of the invention there is provided a chocolate product obtained or obtainable by the process of the first aspect of the invention.

The chocolate product may be a milk chocolate product. The chocolate product may be a non-milk or low milk containing product such as a dark chocolate product or a white chocolate product. The chocolate product may be stored as a liquid prior to solidifying into a solid chocolate product in a step following step b). The solid chocolate product may be a tablet, a bar, a shell or any other suitable format. The solid chocolate product may be a filled chocolate confectionery.

In some embodiments the chocolate product may be a chocolate coating. In some embodiments the chocolate product may be a chocolate filling.

### DETAILED DESCRIPTION OF THE INVENTION

In order that the invention may be more clearly understood embodiments thereof will now be described, by way of example only, with reference to the accompanying drawings, of which:

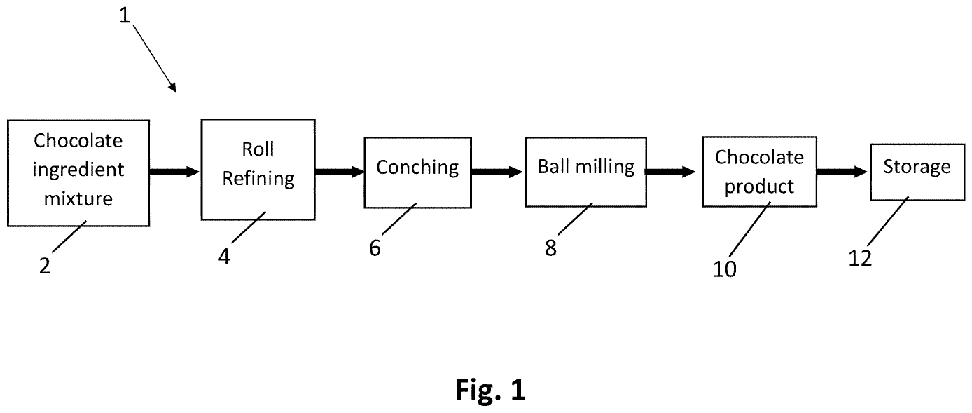

FIG. 1 illustrates a flow diagram illustrating a first embodiment of a method of manufacturing chocolate of the invention comprising a refining size reduction step followed by a conching step followed by a ball milling step.

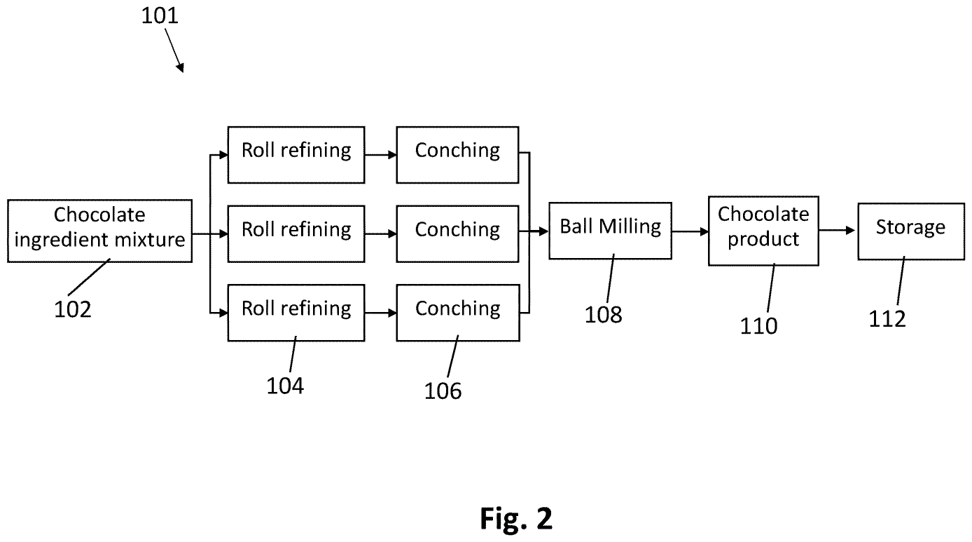

FIG. 2 illustrates a flow diagram illustrating a second embodiment of a method of manufacturing chocolate of the invention comprising a plurality of refining size reduction steps followed by a plurality of conching steps followed by a ball milling step.

### EXAMPLE 1

A flow diagram of a first embodiment of a method of manufacturing chocolate of the invention is illustrated in FIG. 1.

The method (1) of manufacturing a chocolate product (10) comprised adding a chocolate ingredient mixture (2) into a roll refiner and performing a size reducing, roll refining step (4) in a roll refiner followed by a conching step (6). The particle size distribution of the chocolate ingredient mixture was reduced during the roll refining step (4) from a D90 value of least 150 μm before the roll refining step (4) to 30-35 μm after the roll refining step (4). The particle size was not significantly reduced further in the conching step (6). The particle size distributions were measured using a Malvern Mastersizer 3000 (supplied by Malvern Panalytical Ltd, UK).

Following the conching step (6), the chocolate ingredient mixture with a particle size distribution with a D90 value of 30-35 μm entered a ball milling step (8) wherein the particle size was further reduced by 2.5-12 μm. The output from the ball milling step (8) was a chocolate product (10) comprising a particle size distribution with a D90 value of 23-27.5 μm. The chocolate product (10) was then stored in a storage area (12) prior to solidification into a final solid chocolate product.

The method of the Example and the invention in general is not limited to the production of a chocolate product from any specific starting ingredients. The method may be used with any ingredients normally used in chocolate manufacture, including but not limited to cocoa source ingredients such as cocoa powder or cocoa liquor, fat sources such as cocoa butter or vegetable fat, sweeteners and/or milk products.

### Properties of the Chocolate Products

Chocolate products A to F were manufactured according to the method of the first embodiment of the invention described above in Example 1. The ingredients of the chocolate products A to F were sugar 47% wt., cocoa butter 18% wt., milk powder 23% wt., cocoa 11% wt. and soy lecithin 1% wt. The ball mill used in the ball milling step of the manufacture of the chocolate products A to F was a 7 litre horizontal ball mill and the ball mill was filled with 77% 3 mm beads and 23% 5 mm beads to create a bead fill level of 76%. The ball mill shaft speed was set to 11 m/s, 13 m/s or 16 m/s, and the ball mill throughput was set to 380, 260, 150 or 80 kg/hr. All parameter combinations are shown in table 1.

The temperature of the chocolate products (exit temperature) and the D90 particle size distribution values of the chocolate products were measured after ball milling and the data is shown in table 1.

TABLE 1

| | | | D90 particle | D90 particle | Exit |
|---|---|---|---|---|---|
| | Ball mill | | size | size | temperature of |
| | shaft tip | Ball mill | distribution | distribution | the chocolate |
| Chocolate | speed | throughput | before ball | after ball | product from the |
| product | m/s | Kg/hr | milling, μm | milling, μm | ball mill, ° C. |
| A | 11 | 380 | 30 | 26.3 | 47.7 |
| B | 11 | 380 | 30 | 27.0 | 47.7 |
| C | 13 | 380 | 30 | 25.3 | 50.3 |
| D | 11 | 80 | 30 | 23.0 | 51.1 |
| E | 13 | 150 | 30 | 24.3 | 54.2 |
| F | 11 | 260 | 30 | 27.4 | 52.9 |

By refining the chocolate ingredient mixture to 30-35 μm (D90 particle size distribution before ball milling), conching and then ball milling the chocolate ingredient mixture to the desired particle size of 23-27.5 μm instead of refining the chocolate ingredient mixture to 23-27.5 μm and conching without a ball milling step, the throughput of the manufacturing process can be increased by 25% and the lifetime of the refining rollers can be significantly extended thereby minimising down time and maintenance costs without detriment to the chocolate product characteristics such as flavour, texture and mouthfeel.

As shown by the data in table 1, the chocolate product produced after the ball milling step according to the inventive manufacturing process produces a uniform chocolate product across a range of ball milling conditions wherein the D90 particle size distribution of the chocolate product is consistently within the desired target range of 23-28 μm.

### EXAMPLE 2

A second embodiment of the method of manufacturing chocolate of the invention is illustrated in FIG. 2. The method (101) of manufacturing a chocolate product (110) comprised inputting a chocolate ingredient mixture (102) into a plurality of roll refiners for a plurality of size reducing, roll refining steps (104) such that the chocolate ingredient mixture (102) could pass through multiple roll refiners in parallel. The plurality of roll refining steps (104) was followed by a plurality of conching steps (106) in parallel. The particle size of the chocolate ingredient mixture was reduced from a D90 value of at least 150 μm before the roll refining steps (104) to 30-35 μm after the roll refining steps (104). The particle size was not reduced further in the conching steps (106).

The resulting particle size reduced chocolate ingredient mixture from the conching steps (106) entered a ball milling step (108) wherein the particle size was further reduced by 2.5-12 μm and the output from the ball milling step (108) was a chocolate product (110) comprising a particle size distribution of 23-27.5 μm. The ball milling step (108) was essentially the same as the ball milling step of the first embodiment of the invention and the resulting chocolate product (110) was essentially the same as the resulting chocolate product of the first embodiment of the invention described in Example 1.

The typical throughput of the roll refiners (104) is between 900-1200 kg/h. Reducing the particle size distribution of the chocolate ingredient mixture to 30-35 μm during the roll refining step (104) instead of to the desired particle distribution of the final chocolate product (23-27.5 μm), increases refiner throughput in the manufacturing process. The throughput of the ball milling (108) step can be as high as 5000-6000 kg/h therefore by adding the ball milling (108) step at the end of the manufacturing process, after the conching steps (106), the manufacturing efficiency of the method of manufacturing according to the invention is increased. The throughput of the chocolate product (110) is increased by 25% when compared to a method wherein the roll refining step reduces the particle size of the chocolate ingredient to the desired particle size of the end product and the method does not comprise a ball milling step after the refining and conching step.

The above embodiments are described by way of example only. Many variations are possible without departing from the scope of the invention as defined in the appended claims.

1. A method of manufacturing a chocolate product comprising the steps of:
a) size reducing a chocolate ingredient mixture followed by conching the chocolate ingredient mixture; and
b) ball milling the chocolate ingredient mixture formed in step a) to form a chocolate product comprising a particle size distribution which is reduced compared to the chocolate ingredient mixture formed in step a),
wherein the chocolate ingredient mixture at the end of step a) comprises a particle size distribution with a D90 value of 20-100 μm and the chocolate product at the end of step b) comprises a particle size distribution with a D90 value of 15-35 μm and which is less than the particle size distribution formed in step a).

2. A method according to claim 1 wherein the size reducing step of step a) comprises refining, preferably in at least one roll refiner.

3. A method according to claim 2 wherein step a) comprises refining the chocolate ingredient mixture in a 2-roll refiner followed by a 5-roll roll refiner.

4. A method according to claim 1 wherein the D90 particle size distribution of the chocolate ingredient mixture prior to step a) is no more than 1500 μm.

5. A method according to claim 4 wherein the D90 particle size distribution of the chocolate ingredient mixture is reduced from 100-1500 μm to 20-100 μm in the size reduction step of step a), preferably reduced to 28-40 μm.

6. A method according to claim 1 wherein the D90 particle size distribution of the chocolate ingredient mixture formed in step a) is reduced by 2-80 μm in the ball milling step of step b).

7. A method according to claim 1 wherein the ball milling step is carried out at 30-80° C.

8. A method according to claim 1 wherein the chocolate ingredient mixture comprises at least one cocoa ingredient selected from the group comprising cocoa nibs, cocoa powder, cocoa butter and cocoa liquor.

9. A method according to claim 1 wherein after step b) the chocolate product is stored as a liquid prior to solidifying into a solid chocolate product.

10. A method according to claim 1 wherein no additional chocolate ingredients are added to the chocolate ingredient mixture during step a), between step a) and step b), and/or during step b).
